(19) United States
(12) Patent Application Publication
(10) Pub. No.: US 2021/0305700 A1
(43) Pub. Date: Sep. 30, 2021

(54) Compact Antenna Technology for Wireless Communications

(71) Applicant: Fractus Antennas, S.L., Barcelona (ES)

(72) Inventors: Jaume ANGUERA, Castello (ES); Aurora ANDÚJAR, Barcelona (ES); Carles PUENTE, Barcelona (ES)

(21) Appl. No.: 17/345,835

(22) Filed: Jun. 11, 2021

Related U.S. Application Data
(63) Continuation of application No. PCT/EP2019/084680, filed on Dec. 11, 2019.
(60) Provisional application No. 62/870,837, filed on Jul. 5, 2019.
(60) Provisional application No. 62/777,835, filed on Dec. 11, 2018.

(30) Foreign Application Priority Data
Dec. 11, 2018 (EP) 18211745.7
Jul. 5, 2019 (EP) 19184772.2

(51) Int. Cl. H01Q 9/04; H01Q 15/12; H01Q 1/24

(52) U.S. Cl. CPC H01Q 9/0407; H01Q 1/242; H01Q 15/12

(57) ABSTRACT

A wireless device using a radiating system able to operate in more than one communication system features compact dimensions and comprises a radiating structure that contains a compact booster arrangement that comprises first and second boosters, arranged in a configuration such that the boosters are not concatenated between them, i.e., not being placed one next to each other. One of the boosters comprises a slot or a gap in a ground plane layer and another of the boosters comprises at least a conductive part or element connected at a point to an additional conductive element that comprises a feeding point. The radiating structure also comprises the ground plane layer and a radiofrequency system. The radiating system also comprises one or two ports, each providing operation at least at one of the communication systems of operation.

### CROSS REFERENCE TO RELATED APPLICATIONS

This application is a continuation of International Application No. PCT/EP2019/084680, filed on Dec. 11, 2019, which claims priority under 35 U.S.C. § 119 to Application No. EP 19184772.2 filed on Jul. 5, 2019, Application No. EP 18211745.7 filed on Dec. 11, 2018, and also claims the benefit of U.S. Provisional Application No. 62/777,835, filed on Dec. 11, 2018, and claims the benefit of U.S. Provisional Application No. 62/870,837, filed on Jul. 5, 2019, the entire contents of which are hereby incorporated by reference.

### TECHNICAL FIELD

The present invention relates to the field of wireless devices requiring operation at more than one communication systems and/or frequency bands.

### BACKGROUND

Nowadays, wireless devices usually require functionality at different communications systems since they are required to cover different applications, normally requiring different communication protocols or standards, those different communication systems normally operating at different frequency regions. Then, a wireless device platform comprising a radiating system able to cover those functionality requirements is nowadays a must and a challenge due to the reduced free space available in a wireless device for allocating a radiating system.

Current antenna technology already tries to overcome the difficulties that arise when integrating a radiating system in a wireless device. PCT publication No. WO/2019008171 provides a versatile solution already capable of covering different communication protocols or standards, by providing a modular antenna system that comprises an antenna component comprising different sections that allow to configure the antenna system for covering different communications systems and more than one. An antenna system disclosed in PCT publication No. WO/2019008171 is characterized by requiring a single piece or unit for implementing it. This multi-section arrangement features a coupling between sections that makes difficult, in some configurations, to isolate the different ports of the antenna system. Depending on the communication systems that the wireless device needs to cover, an antenna system disclosed in PCT publication No. WO/2019008171 can require matching networks including several filters to isolate its different ports, each port typically covering operation at one of the communication systems. The use of multiple filters can degrade the performance achievable by the solution. Another improvable characteristic of an antenna system disclosed in PCT publication No. WO/2019008171 are the dimensions of the piece hosting an antenna system comprising a multi-section antenna component since a multi-section antenna component as disclosed in PCT publication No. WO/2019008171 typically includes concatenated sections, arranged one next to each other.

U.S. Pat. No. 9,379,443 discloses radiating systems comprising one or more, typically two, radiation boosters coupled to a close ground plane layer for covering operation at multiple frequency regions. The booster technology provided in U.S. Pat. No. 9,379,443 is based on compact radiation boosters solutions where the coupling and distance between boosters, for the case of several boosters, have been characterized for developing those solutions. However, even if those solutions are more compact than the previous ones the space occupied by those boosters configurations may still be reduced while at least preserving the achieved performance. Regarding radiation boosters technology, U.S. Pat. No. 9,331,389 also provides multiple compact and small-size radiation boosters proposed for covering operation in a single or multiple frequency bands. U.S. Pat. No. 8,237,615 also discloses some other multi-band antennaless configurations. U.S. Pat. No. 8,203,492 presents the antennaless technology based on the use of boosters as exciting elements of radiation modes in a ground plane layer of a radiating system.

So, as introduced before, radiating systems including radiating structures of reduced or compact dimensions capable of operating at different frequency bands and communication systems and standards, so providing operation at different applications, while providing a suitable performance are an advantageous solution. The invention here disclosed provides a wireless device and a radiating system able to operate at more than one communication system, advantageously two, while providing a compact radiating structure that performs efficiently, and which can additionally be mounted at any position of a wireless platform.

### SUMMARY

It is an object of the present invention to provide a wireless device using a radiating system able to operate in more than one communication system, advantageously two, featuring reduced dimensions by comprising a compact radiating structure that contains a compact booster arrangement. It has been found that a booster arrangement that comprises first and second boosters, arranged in a configuration such that the boosters are not concatenated between them, i.e., not being placed one next to each other, the booster arrangement comprising a booster featuring a configuration that comprises a slot or a gap contained in a ground plane layer and comprising a booster that comprises a conductive part connected at a point to a feeding point by an additional conductive element, provides a compact booster arrangement that features isolated boosters. As previously described, the booster arrangement comprises a booster comprising a slot or a gap contained in a ground plane layer, the slot or gap fed by a feeding element, usually a feeding line, being a strip line in some embodiments, and it comprises a booster comprising at least a conductive part or element connected at a point to an additional conductive element, usually a via but not limited to this type of conductive element, the additional conductive element comprising a feeding point. A booster arrangement related to this invention is also characterized by having an additional conductive element positioned at a distance d1 defined from the edge of its corresponding boosters piece of the booster arrangement from which the slotted booster's feeding element is located, and by having a slotted booster's feeding element located at a distance d2 from a closest edge of the boosters piece, such that the additional conductive element and the slotted booster feeding element are positioned at a distance d3 from each other. As already mentioned before, a booster arrangement here described features isolated boosters, and thus provides good isolation between the ports of a radiating system including the booster arrangement, each radiating system port normally related to one booster. In some booster arrangement embodiments, the slotted booster's feeding element is positioned at a distance d2 shorter than the distance d1 at which the additional conductive element of the conductive booster is located. In some of those embodiments, there is no distance between the slot feeding element and the boosters piece edge from which d2 is defined. In other embodiments, the slotted booster's feeding element is positioned at a distance d2 greater than the distance d1 at which the additional conductive element of the conductive booster is located, so that the non-slotted booster's feeding point, that is the feeding point of the additional conductive element of the non-slotted booster, is positioned outside the slot of the slotted booster. It has been found that by allocating the non-slotted booster's feeding point in a position outside the slot of the slotted booster, further improves isolation between boosters and between the radiating system ports related to those boosters. A better isolation of the radiating system ports provides more performant embodiments regarding the achieved efficiency and more robust embodiments in terms of operation. Besides the compactness and isolated boosters of the non-concatenated booster arrangement described herein, another advantage of the boosters configuration is the good performance, particularly in terms of efficiency, achieved for such a compact configuration at the different ports included in the radiating system comprising the booster arrangement, the radiating system providing operation at the sought communication bands and systems. Then, a radiating system according to the present invention comprises a radiating structure comprising first and second boosters arranged as described before, a ground plane layer and a radiofrequency system, the radiating system also comprising at least one port, advantageously two, each port providing operation at at least one of the communication systems of operation.

In the context of the present invention, at least one of the boosters is included in a boosters piece as described along this text, the boosters piece exciting the proper radiation modes on the ground plane layer to provide operation at the sought communications systems, the boosters piece normally configured such that each booster included in it operates at least at one communication system, providing operation at at least one port of the radiating system. In some embodiments of a radiating system related to this invention one of the boosters of the radiating structure is not contained in a boosters piece but in the PCB that contains the radiating structure and system.

The radiofrequency system included in a radiating structure of a radiating system here disclosed comprises at least a matching network that matches the radiating structure at the sought frequency bands and at the corresponding communication systems at the corresponding radiating system port or ports, when more than one matching network are comprised, and at least one filter included in radiating systems configured for operating at more than one port, the filter added for improving the isolation between ports at the operation bands, each filter blocking the frequencies of operation corresponding to another port or ports. Advantageously, the radiofrequency system comprises one matching network and one filter for matching each port of the radiating system, so that the number of ports and filters and matching networks is the same. But some radiating system embodiments comprise fewer filters than ports and some embodiments comprise fewer matching networks than ports.

A radiating system according to this invention can also be configured in a single-port configuration if desired, so the radiating system just including one port, but this is not the most typical use of a radiating system related to this invention. Normally, a radiating system related to this invention is configured in a two-port configuration. In some embodiments of a radiating system comprising more than one port, each booster of the booster arrangement or the boosters piece of the radiating system provides operation at one port. In some other embodiments, one of the boosters of the booster arrangement or the boosters piece provides operation at two ports.

A boosters piece related to the present invention normally comprises first and second boosters, arranged in a compact configuration where the boosters are not concatenated between them, the configuration minimizing the coupling between boosters and improving the isolation between ports related to different boosters, and thus improving the performance achieved, particularly in terms of efficiency, at the communication systems of operation of the radiating system. The first booster comprises at least a conductive element or part contained in a non-perpendicular plane regarding the plane containing the ground plane layer, at least one of the conductive element or elements containing at least one connection point. The first booster also comprising at least one additional conductive element connected to the at least one connection point, and one of those additional conductive elements containing a feeding point, the additional conductive element included in the boosters piece. The at least one additional conductive element is in some embodiments a via. The second booster comprises a feeding element comprising a feeding point, the feeding element contained in a surface or face of the boosters piece for some embodiments of radiating structure, the surface or face also contained in a non-perpendicular plane regarding the plane containing the ground plane layer of the radiating structure. The surface or face containing the feeding element is normally a non-conductive surface. Advantageously, in some boosters piece embodiments the feeding element is contained in a plane parallel to the plane that contains the ground plane layer of the radiating structure. In some other boosters piece embodiments, the feeding element is contained in an outer face of the boosters piece. More specifically, in other embodiments, the feeding element is contained in an outer bottom face of the boosters piece, the face parallel to the plane that contains the ground plane layer of the radiating structure. In some boosters piece embodiments, the feeding element is a strip line. The feeding element contained in the second booster excites a slot or gap contained in the ground plane layer of the radiating structure of a radiating system related to this invention. The boosters piece also comprises at least one non-electrical connection element added for mechanical purposes for fixing or attaching, or more concretely soldering, the piece to the PCB containing the whole radiating structure. The mechanical connection element being, in some embodiments, one or more connecting points, usually implemented with pads, or a strip in other embodiments, more particularly the strip being a U-shape strip in some of those last embodiments. The combination of those booster configurations in a single piece as described in the context of this invention provides a very compact and performant boosters piece able to provide operation at more than one communication bands and systems, advantageously two. The feeding points included in the boosters piece are connected to the radiofrequency system of the radiating structure once the piece is mounted on PCB that contains the radiating structure and radiating system. The PCB comprises the corresponding connections needed for connecting the feeding points to the radiofrequency system.

The ground plane layer of a radiating structure related to this invention contains a gap or slot contained in a ground plane clearance, the gap or slot defined by a curve, the curve containing first and second connection points connected between them by a feeding element. According to the present invention the feeding element connecting the first and second connection points included in the slot curve is either included in a boosters piece, as already described, or it is included, in other embodiments, in the slot itself by, for example, printing it on the PCB that supports the radiating structure containing the ground plane layer that contains the slot. In some other embodiments, the feeding element could even be comprised both in the boosters piece and in the PCB containing the slot.

A radiating system related to this invention comprises a radiating structure including a ground plane layer, a radiofrequency system and a boosters piece of reduced dimensions, featuring a largest dimension smaller than λ/20, where λ is the free-space wavelength corresponding to the lowest frequency of operation of the radiating system or wireless device, the largest dimension being defined by the largest dimension of a box that completely encloses the boosters piece, and in which the radiation booster is inscribed. More concretely, the box is defined as being the minimum-sized parallelepiped of square or rectangular faces that completely encloses the boosters piece, wherein each one of the faces of the minimum-sized parallelepiped is tangent to at least a point of the boosters piece and wherein each possible pair of faces of the minimum-size parallelepiped sharing an edge forms an inner angle of 90°. A boosters piece related to this invention is mounted on a ground plane clearance contained in the ground plane layer of a radiating structure according to the present invention, the ground plane clearance being an area without ground plane, and thus being an area lacking ground properties. An advantage of a booster arrangement and/or a boosters piece related to this invention is that it performs correctly in terms of bandwidth and efficiency when it is mounted on a ground plane clearance as big as its footprint. If the space available in the wireless device for allocating the boosters piece is larger than its footprint, the ground plane clearance used for hosting the booster arrangement and/or piece can be larger, so that the performance of the corresponding radiating structure can be increased. Then, some embodiments of a radiating structure feature a clearance larger than the dimensions of the footprint of the boosters piece included in the radiating structure, other embodiments feature a clearance smaller than the footprint, and others advantageously feature a clearance area as big as the footprint of the boosters piece. More particularly, some of those embodiments feature a booster slot as big as the ground plane clearance and some other embodiments feature a ground plane clearance greater than the booster slot. Being able to minimize the necessary space for allocating the boosters piece, to the boosters piece footprint is an additional advantage of the invention here disclosed.

Additionally, some boosters piece embodiments are symmetric. The symmetry of a boosters symmetric piece allows to mount the piece at different locations on a clearance of the ground plane layer of the radiating structure of a radiating system according to this invention. Then, having a radiating system including a radiating structure able to be allocated at any position of the wireless device platform is also an advantage.

### BRIEF DESCRIPTION OF THE DRAWINGS

The mentioned and further features and advantages of the invention become apparent in view of the detailed description which follows with some examples of the invention, illustrated by the accompanying drawings, given for purposes of illustration only but not as a definition of any limits of the invention.

FIG. 1 illustrates an embodiment of a boosters piece according to the present invention, comprising two non-concatenated boosters, one of them being a slot-based booster, the boosters piece including two feeding points, one feeding point per booster, and able to operate at more than one communication systems. The piece is shown mounted on a ground plane layer included in a radiating structure related to the invention. For this embodiment, the piece length is longer than its width.

FIG. 2 illustrates another embodiment of a boosters piece according to the present invention, also comprising two non-concatenated boosters, one of them being a slot-based booster, the boosters piece including two feeding points and featuring a length to width ratio less than 1. The piece is placed along a ground plane edge of a ground plane layer of a radiating structure related to the invention.

FIGS. 3a and 3b illustrates some embodiments of a non-concatenated booster arrangement containing a slot-based booster in the PCB that supports a radiating structure and system related to the invention, which comprises a boosters piece comprising a non slot-based booster. More specifically the feeding element used for exciting the slot required for implementing the slot-based booster is printed on the PCB and not in the boosters piece.

FIG. 4 shows a generic example of a radiofrequency system included in a radiating structure according to the present invention.

FIG. 5 illustrates different positions of a boosters piece related to this invention once mounted on a ground plane layer of a radiating structure according to this invention.

FIG. 6 illustrates an example of a radiating structure containing a boosters piece according to this invention, featuring a length to width ratio greater than 1 and located in a middle position of a longer edge of the ground plane layer.

FIG. 7 shows a boosters piece according to the invention, comprising a conductive booster containing a vertical conductive line fed at its feeding point. The slotted booster is fed in this embodiment by a strip line containing a feeding point at one of its ends.

FIG. 8 illustrates the radiofrequency system of a radiating structure embodiment like the one shown in FIG. 6, containing a boosters piece like the one shown in FIG. 7, for matching a radiating system of two ports operating at Bluetooth and GNSS services.

FIG. 9 illustrates the input reflection coefficients and the isolation between ports related to a radiating structure embodiment shown in FIG. 6, comprising the boosters piece shown in FIG. 7 and the radiofrequency system shown in FIG. 8.

FIG. 10 shows the antenna efficiencies related to a radiating system embodiment that comprises a radiating structure embodiment shown in FIG. 6, the radiating structure comprising the boosters piece shown in FIG. 7 and the radiofrequency system shown in FIG. 8, the radiating system matched as shown in FIG. 9.

FIG. 11 illustrates a footprint of a boosters piece and boosters configuration related to this invention, on a ground plane layer of a radiating structure embodiment like the one shown in FIG. 6. A pad configuration for allocating a radiofrequency system is also shown.

FIG. 12 illustrates a radiofrequency system of a radiating structure embodiment featuring a footprint like the one shown in FIG. 11, for matching a radiating system of two ports operating at Bluetooth and GNSS bands.

FIG. 13 illustrates another boosters piece according to this invention, comprising a conductive booster that comprises two vertical vias, one of them fed at a feeding point contained at the end not connected to the conductive surface of the conductive booster. The slotted booster is fed in this embodiment by a strip line containing a feeding point at one of its ends. This piece features a symmetric shape.

FIG. 14 illustrates the radiofrequency system in a radiating structure embodiment like the one provided in FIG. 6, containing a boosters piece like the one shown in FIG. 13, for matching a radiating system of two ports operating at Bluetooth and GNSS services.

FIG. 15 shows measured input reflection coefficients between the ports in a radiating system that comprises a radiating structure embodiment shown in FIG. 6, comprising the boosters piece shown in FIG. 13 and the radiofrequency system shown in FIG. 14.

FIG. 16 shows the measured antenna efficiency related to the GNSS port of a radiating system embodiment that comprises a radiating structure embodiment shown in FIG. 6, the radiating structure comprising the boosters piece shown in FIG. 13 and the radiofrequency system shown in FIG. 14, the radiating system matched as shown in FIG. 15.

FIG. 17 shows the measured antenna efficiency related to the Bluetooth port of a radiating system embodiment that comprises a radiating structure embodiment shown in FIG. 6, the radiating structure comprising the boosters piece shown in FIG. 13 and the radiofrequency system shown in FIG. 14, the radiating system matched as shown in FIG. 15.

FIG. 18 illustrates another boosters piece according to this invention, comprising a conductive booster that comprises one vertical via fed at a feeding point at one of its ends. The slotted booster is also fed in this embodiment by a strip line containing a feeding point at one of its ends. This piece contains a slot-based booster that features a slot smaller than the clearance that contains the boosters piece.

FIG. 19 illustrates a boosters piece footprint related to a boosters piece from FIG. 18 and a pads distribution or configuration included in a radiating structure embodiment that comprises the boosters piece, for allocating a radiofrequency system.

FIG. 20 illustrates the radiofrequency system in a radiating structure embodiment like the one shown in FIG. 6, containing a boosters piece like the one shown in FIG. 18, for matching a radiating system of two ports operating at Bluetooth and GNSS bands.

FIG. 21 shows the input reflection coefficient obtained for GNSS frequencies at a port of a radiating system comprising a radiating structure that contains a boosters piece like the one shown in FIG. 18 and the radiofrequency system from FIG. 20.

FIG. 22 illustrates the antenna efficiency obtained at GNSS frequencies at the GNSS port of the radiating system comprising a radiating structure that contains a boosters piece like the one shown in FIG. 18, the radiating system matched at the port as shown in FIG. 21 by means of the radiofrequency system shown in FIG. 20.

FIG. 23 shows the input reflection coefficient obtained for Bluetooth frequencies at the Bluetooth port of a radiating system comprising a radiating structure that contains a boosters piece like the one shown in FIG. 18 and the radiofrequency system from FIG. 20.

FIG. 24 illustrates the antenna efficiency obtained at Bluetooth frequencies at the Bluetooth port of the radiating system comprising a radiating structure that contains a boosters piece like the one shown in FIG. 18, the radiating system matched at the port as shown in FIG. 23 by means of the radiofrequency system shown in FIG. 20.

FIG. 25 illustrates the radiofrequency system in a radiating structure embodiment like the one shown in FIG. 6, containing a boosters piece like the one shown in FIG. 18, for matching a single-port radiating system operating only at the GNSS band.

FIG. 26 shows the input reflection coefficient obtained for GNSS frequencies at the radiating system port related to the slotted booster in the radiating structure included in the radiating system, the radiating structure containing a boosters piece like the one shown in FIG. 18 and the radiofrequency system from FIG. 25.

FIG. 27 illustrates the antenna efficiency obtained at GNSS frequencies at the radiating system port related to the slotted booster in the radiating structure included in the radiating system, the radiating structure comprising a boosters piece like the one shown in FIG. 18, the radiating system matched at the port as shown in FIG. 26 by means of the radiofrequency system shown in FIG. 25.

### DETAILED DESCRIPTION

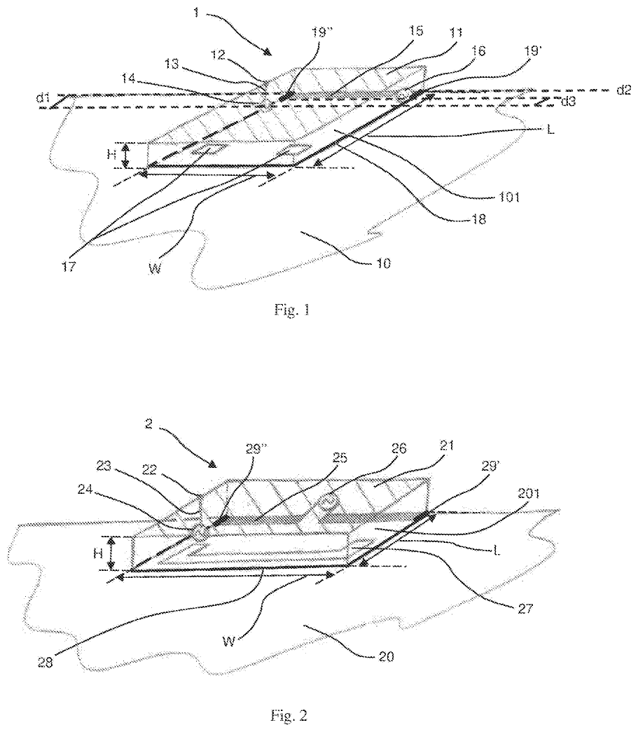

As already described, a radiating system according to this invention comprises a radiating structure containing a compact booster arrangement comprising first and second boosters arranged in a configuration as described herein, normally contained in a single piece, for providing a compact radiating structure able to provide operation at more than one communication system. FIG. 1 and FIG. 2 provide some embodiments of a boosters piece 1, 2 according to the present invention. Those boosters pieces are shown as mounted on a ground plane layer 10, 20 in the radiating structure that contains the boosters pieces. The first booster in a booster arrangement according to this invention and thus, in a boosters piece like the ones shown in FIG. 1 and FIG. 2, comprises at least a conductive element contained in a non-perpendicular plane regarding the plane containing the ground plane layer, for the case of the embodiments from FIG. 1 and FIG. 2 a conductive element 11, 21 is included in the first booster, the conductive element 11, 21 contained in a plane parallel to the ground plane layer 10, 20. At least one of the conductive element or elements contains at least one connection point, in FIG. 1 and FIG. 2 only one connection point 12, 22 is comprised. The first booster also comprises at least one additional conductive element, represented by 13, 23 in the embodiments provided in FIG. 1 and FIG. 2, connected to the at least one connection point, 12 and 22 in FIG. 1 and FIG. 2, one of those additional conductive elements being also connected to a feeding point, defined in the boosters piece, 14 and 24 in the embodiments from FIG. 1 and FIG. 2. The second booster comprises a feeding element comprising a feeding point, the feeding element contained, in some radiating structure embodiments, in a surface or face of the boosters piece, the surface contained in a non-perpendicular plane regarding the plane containing the ground plane layer of the radiating structure. The feeding element in the second booster excites a slot or gap defined in the ground plane layer in the radiating structure. In the embodiments of a boosters piece provided in FIG. 1 and FIG. 2, the feeding element is a strip line 15, 25 printed on the outer bottom face of the boosters piece, the face of the piece being a non-conductive surface. The feeding points 16, 26 in the strip lines contained in the piece embodiments from FIG. 1 and FIG. 2 are located at an end of the strip line for the embodiment in FIG. 1 and at the center of the strip line for the embodiment provided in FIG. 2. Additionally, a boosters piece according to this invention is characterized by a length L, a width W and a height or thickness H, dimensions illustrated in FIG. 1; the length L being a perpendicular dimension to the dimension of the boosters piece along which the slot feeding element is contained; the width W being the dimension of the boosters piece along which the slot feeding element is contained, being both L and W dimensions contained in the same plane; and the thickness H being a perpendicular dimension to the plane that contains both W and L.

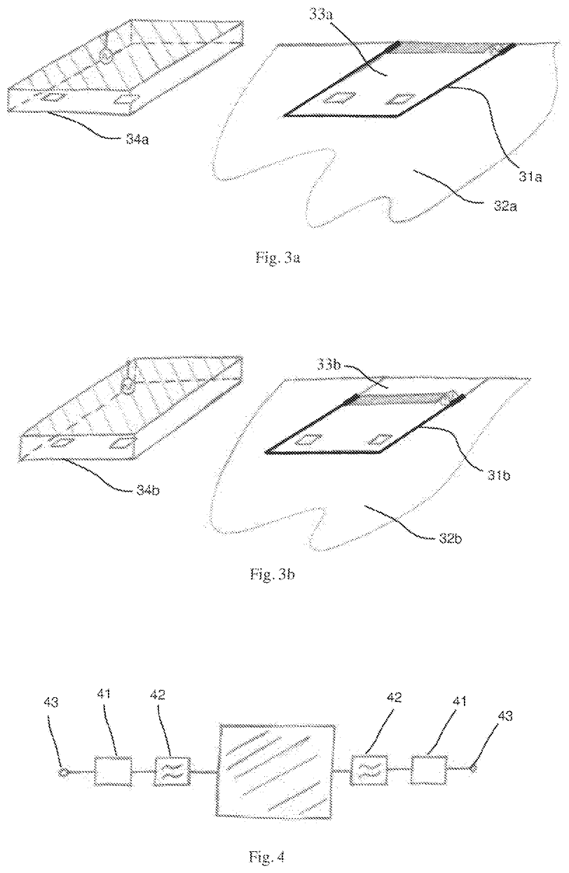

In other embodiments, the feeding element in the second booster in a booster arrangement according to the present invention is printed on the PCB that contains the radiating system, as shown in FIGS. 3a and 3b. FIG. 3a shows a booster arrangement comprising a slot-based booster wherein the slot defined by the curve 31a in the ground plane 32a of the radiating structure is as big as the ground plane clearance 33a. FIG. 3b shows a booster arrangement comprising a slot-based booster wherein the slot defined by the curve 31b in the ground plane 32b of the radiating structure is smaller than the ground plane clearance 33b. A boosters piece related to this invention also comprises at least one non-electrical connection element added for mechanical purposes, i.e., for attaching, or more concretely soldering, the piece to the PCB containing the radiating structure and system. The embodiments provided in FIG. 1 and FIG. 2 contain two floating connecting pads 17 and a U-shaped strip 27, respectively, as non-electrical connecting elements. The ground plane layer in a radiating structure related to this invention contains a gap or slot contained in a ground plane clearance in the ground plane layer, the gap or slot defined by a curve, the curve, 18 and 28 in the embodiments from FIG. 1 and FIG. 2, containing first and second connection points, 19′ and 19″, and 29′ and 29″, respectively in the embodiments, connected between them by a feeding element, the feeding element included in the boosters piece in the radiating structure embodiments provided in FIG. 1 and FIG. 2, as described before. Then, a boosters piece related to this invention is mounted on a ground plane clearance contained in the ground plane layer in the radiating structure according to the invention. As shown in the radiating structures from FIG. 1 and FIG. 2, for those embodiments the ground plane clearance 101, 201 is advantageously as big as the footprint of the boosters piece mounted on it.

The PCB containing a radiating system disclosed herein contains the necessary connection points for electrically and mechanically connecting the boosters piece in the radiating structure to the radiofrequency system and the PCB respectively. FIG. 4 shows a generic radiofrequency system in a radiating structure related to this invention. The radiofrequency system typically comprises a matching network 41 and a filter 42 for matching each port 43 in the radiating system, so that the number of ports 43 and the number of filters 42 and matching networks 41 are the same. Each one of those filters blocks the frequencies of operation covered by another port of the radiating system. So, in a radiating system containing two ports, like the one shown in FIG. 4, each filter included at a port blocks the operation frequencies of the other port. But depending on the communication systems that the wireless device and radiating system need to cover, some radiating system embodiments comprise a smaller number of filters than number of ports and some other embodiments even comprise a smaller number of matching networks than the number of ports.

Another characteristic of a radiating system related to this invention is its capability of integration at any location of the wireless device platform that allocates the radiating system. FIG. 5 provides a sketch showing some possible positions 51 of a boosters piece related to this invention once mounted on a ground plane layer 52 in a radiating structure included in the radiating system.

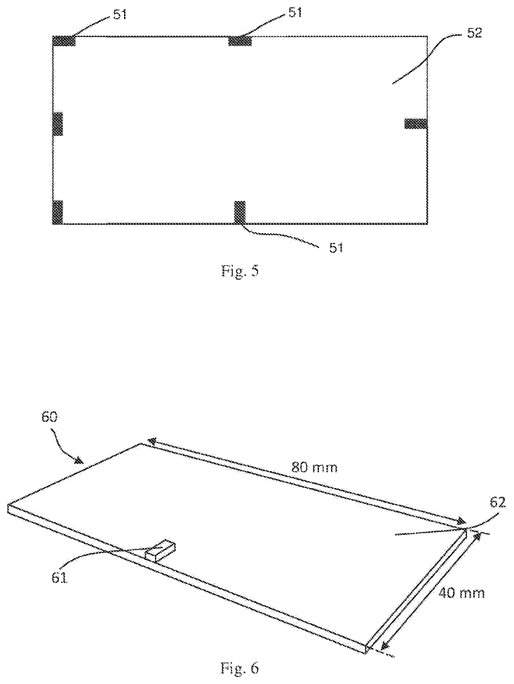

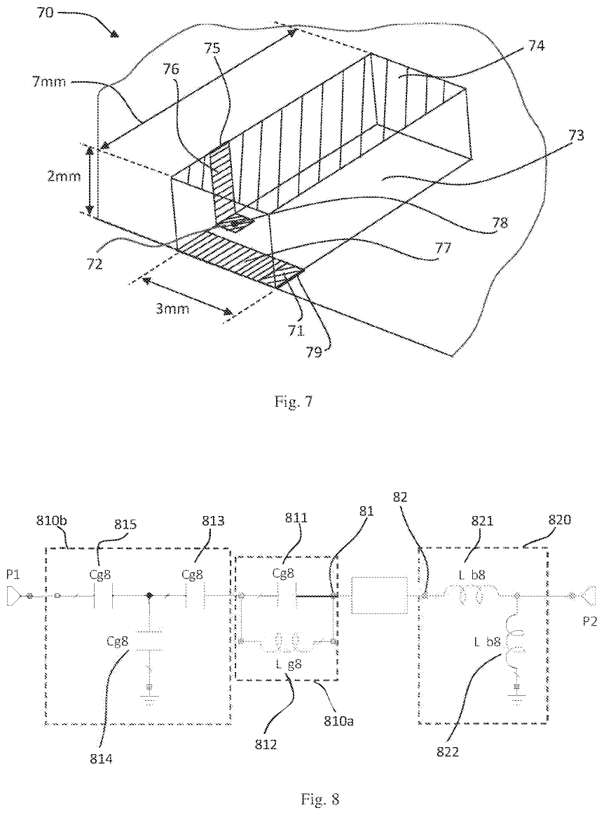

FIG. 6 provides a radiating structure 60 containing a boosters piece 61 according to this invention, the piece featuring a length to width ratio greater than 1 and located in a middle position of a longer edge of the ground plane layer in the radiating structure. The dimensions of the ground plane layer 62 are 80 mm by 40 mm as shown in FIG. 6. Other embodiments of this radiating structure comprise a ground plane layer featuring other dimensions. A more detailed picture of the boosters piece in the radiating structure embodiment provided in FIG. 6 is illustrated in FIG. 7. The piece dimensions are 7 mm×3 mm×2 mm (L×W×H) so the length to width ratio is larger than 1. The piece comprises a first booster comprising a conductive surface 74 contained in the top surface of the piece, the conductive surface containing a connection point, being a connection edge 75 for this example. The first booster also comprises a vertical conductive line connected to the connection edge and to the feeding pad 72, which contains a feeding point 78. The vertical conductive line is in this embodiment a strip 76, featuring a width of 1 mm and a length of 2 mm. In some other embodiments, the vertical conductive line is implemented by a via featuring a length and a diameter, the via being even a hand-made wire in some embodiments. The piece also comprises a second booster whose functioning configuration requires a slot 73 contained in the ground plane layer on which the boosters piece is mounted. The slot is placed in the middle of one of the longest edges of the ground plane layer for the radiating structure embodiment here described and shown in FIG. 6. The slot is fed by a strip line 77 of 1 mm width, connected to a feeding pad 71, which is located at an end of the strip line, the feeding pad containing a feeding edge or point 79. The strip line is connected at its other end point to the ground plane layer in the radiating structure. The feeding points included in the piece are connected to a radiofrequency system for matching purposes.

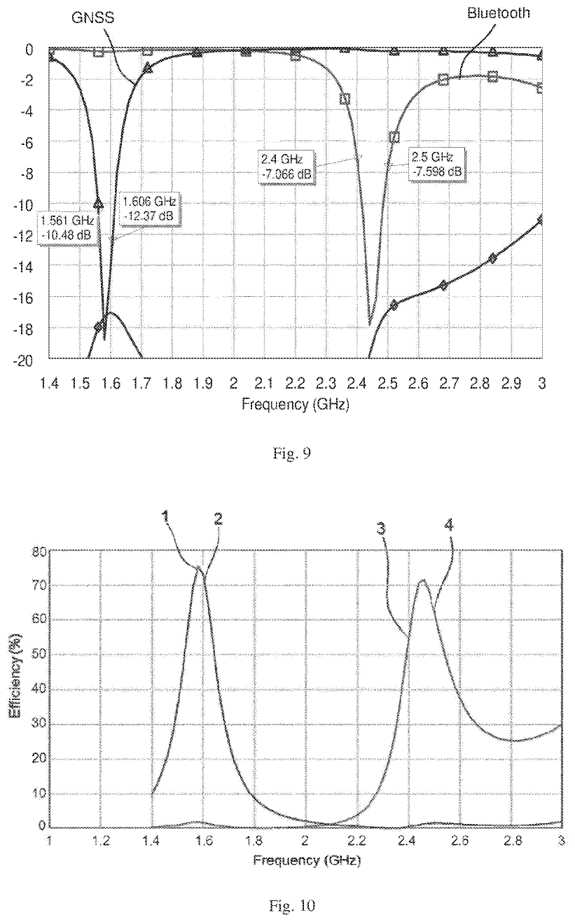

The radiofrequency system implemented and in the radiating structure example from FIG. 6 comprises two matching networks, provided in FIG. 8, one per feeding point and radiating system port, but one filter instead of two. The feeding point 72, or equivalently the connection point 82 in FIG. 8, is directly connected to a matching network 820 that matches the radiating structure at Bluetooth frequencies at port P2, going from 2,400 MHz to 2,500 MHz, while the feeding point 71, or equivalently the connection point 81 in FIG. 8, is connected to a filter 810a rejecting Bluetooth frequencies before being connected to a matching network 810b that completes the matching of the radiating structure at the corresponding port P1 for GNSS frequencies, going from 1,561 MHz to 1,606 MHz. In this particular radiating system embodiment, the filter 810a comprises a capacitor 811 and an inductor 812 connected in parallel between them, the capacitor of 0.8 pF and the inductor of 5.8 nH. The matching network 810b is a T-network comprising three capacitors, a first series capacitor 813 of 0.5 pF, a second shunt capacitor 814 of 0.8 pF and a third series capacitor 815 of 1.2 pF. Finally, the matching network 820 comprises a first series inductance 821 of 3.1 nH followed by a shunt inductance 822 of 1.58 nH or 1.6 nH. So, the boosters piece 70 in the radiating structure 60 illustrated in FIG. 6 is configured as described before for providing operation at Bluetooth and GNSS services. FIG. 9 provides the input reflection coefficient obtained at the frequency bands of operation of both the communication services, each service provided at one of the ports included in the radiating system. At GNSS the input reflection coefficient obtained is below −10 dB and at Bluetooth an input reflection coefficient below −7 dB is achieved. FIG. 10 provides the antenna efficiencies related to the radiating structure embodiment from FIG. 6, when it is matched as shown in FIG. 9 at GNSS and Bluetooth frequencies, from 1,561 MHz (marker 1 in FIG. 10) to 1,606 MHz (marker 2 in FIG. 10) and from 2,400 MHz (marker 3 in FIG. 10) to 2,500 MHz (marker 4 in FIG. 10), respectively. The antenna efficiency at GNSS is above 70% in the whole band and the minimum antenna efficiency achieved at Bluetooth is 55%, obtained at 2,400 MHz.

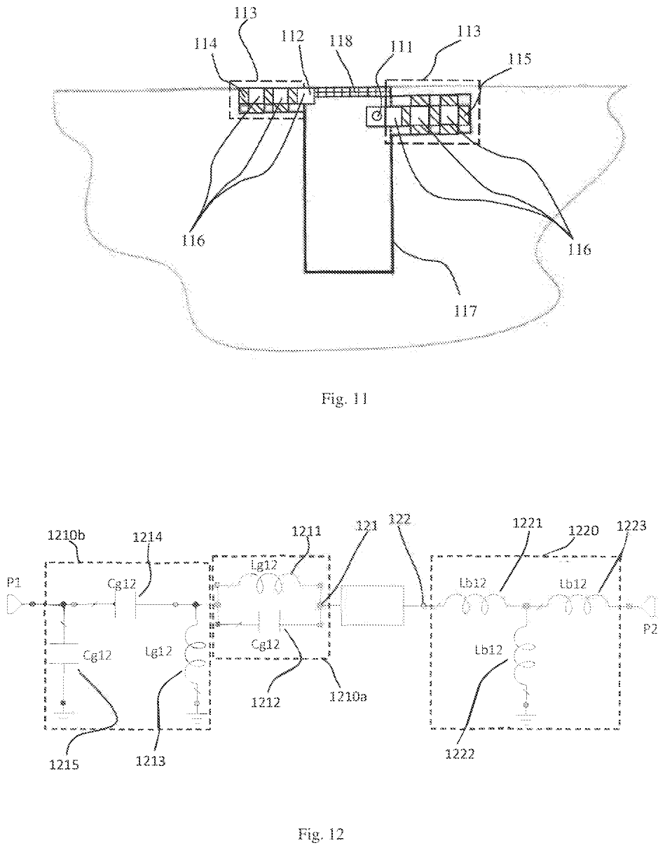

Another radiating structure embodiment in a radiating system related to this invention is provided in FIG. 11, which shows a footprint of the boosters piece included in the radiating structure, which is required to operate at GNSS and Bluetooth services. The dimensions of the ground plane layer in the radiating structure are also 80 mm×40 mm, and the boosters piece is placed at a middle point of a long edge of the ground plane. The dimensions of the boosters piece are the same as the dimensions of the piece included in the radiating structure embodiment from FIG. 6 and shown in FIG. 7. This embodiment of radiating structure includes some pads 116 in the ground plane layer, more concretely six in total, for enabling the allocation of the matchings and filters in the radiofrequency system. The dimensions of those pads are 1 mm×1 mm for this particular embodiment, but they can feature a size within a range between 0.5 mm×0.5 mm and 2 mm×2 mm in other embodiments, normally being square pads but their shape not limited to a square one in other embodiments. Those pads are spaced apart by a 0.5 mm gap. In some embodiments the pads are 2 mm×2 mm. In this embodiment the conductive element in the top surface of the piece is connected to a via of 0.5 mm diameter, which is also connected to feeding point 111, the feeding point connected to the radiofrequency system allocated in the pads area 113. The width of the strip line that feeds the ground plane slot defined by curve 117, represented in the boosters piece footprint provided in FIG. 11 by the strip line 118, and which is included in the second booster in the boosters piece is 0.5 mm. The radiofrequency system in this embodiment is provided in FIG. 12, it comprises a Bluetooth filter 1210a connected to a matching network 1210b connected to the feeding point 112 for matching port 114 at GNSS frequencies and it comprises a matching network 1220 without any filter connected at feeding point 111 for matching port 115 at Bluetooth frequencies. Very good matching values are achieved at both ports 114 and 115 after including the radiofrequency system mentioned before in the radiating structure, more concretely an input reflection coefficient below −9 dB at GNSS and below −8 dB at Bluetooth. This particular embodiment features very good isolation between ports, below −19 dB in both frequency bands of interest, and the corresponding antenna efficiencies achieved for this radiating structure and system are above 50% in the entire frequency ranges of operation.

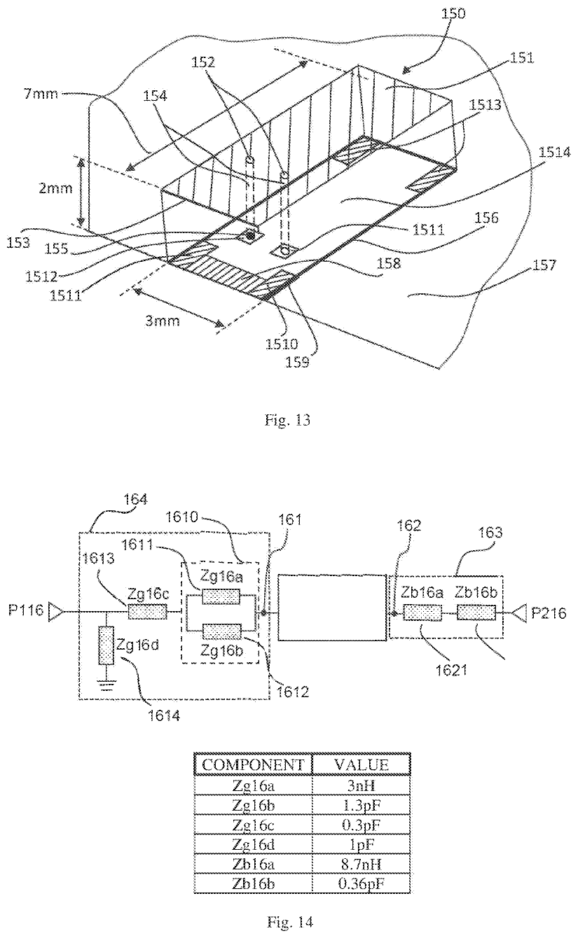

FIG. 13 shows another embodiment of a boosters piece 150 related to this invention, which is included in some embodiments of radiating structures like the one provided in FIG. 6. The piece dimensions are 7 mm×3 mm×2 mm (L×W×H), so the length to width ratio is greater than 1. This piece comprises a first booster comprising a conductive surface 151 contained in the top surface of the piece, the conductive surface containing two connection points 152 at a distance from a short edge 153 of the boosters piece. The first booster also comprises two vertical conductive lines 154, more concretely two vias of 0.5 mm diameter for this particular case, connected to the connection points. Normally, one of those vias contains a feeding point 155, and the other via does not. In some embodiments both vias can be connected to a feeding point. Those feeding points are normally included in conductive pads, as illustrated in FIG. 13 by the conductive pad 1512. The piece also comprises a second booster comprising a conductive strip printed along the short edge of the piece from which the connection points 152 included in the top conductive surface to the vias are located. For this particular example, the vias are placed at 2 mm, measured from the vias center, from the short edge of the boosters piece. The strip in the second booster excites the slot defined by curve 156 contained in a clearance 1514 of the ground plane layer 157 on which the boosters piece is mounted. The slot is placed in the middle of one of the longest edges of the ground plane layer in some radiating structure embodiments, as the one shown in FIG. 6, and it is as big as the ground plane clearance where the boosters piece 150 is integrated. The slot is fed by the strip line included in the boosters piece, the strip line 158 featuring 1 mm or 0.5 mm width, connected to a feeding point or edge 159 of a conductive pad 1510, also contained in the boosters piece, the feeding point 159 and conductive pad 1510 comprised at an end point of the strip line 158. The strip line is connected at its other end to another conductive pad 1511, also included in the boosters piece, which connects the strip line to the ground plane layer in the radiating structure that comprises the boosters piece. The mentioned feeding points are connected to the radiofrequency system, provided in FIG. 14, in the radiating structure. Pads areas 113 like the ones shown in the footprint provided in FIG. 11 can be used for allocating the radiofrequency system from FIG. 14. The feeding point 155 in the boosters piece from FIG. 13 is connected to the point 162 in the radiofrequency system from FIG. 14, in some embodiments by a conductive pad on the PCB that allocates the radiating system, as illustrated in the footprint from FIG. 11, the point 162 more concretely comprised for this radiating system example in a Bluetooth matching branch 163 that is connected at its end at port P216. The feeding point 159 is connected to the point 161 of the radiofrequency system provided in FIG. 14, in some embodiments by means of a conductive pad on the PCB that allocates the radiating system, as illustrated again in the footprint from FIG. 11, the point 161 more particularly comprised for this radiating system example in a GNSS matching branch 164 that is connected at its end at port P116. Two floating conductive pads 1513 are added to the piece provided in FIG. 13 and here described, the floating pads used for soldering the boosters piece to the PCB that contains the radiating system that comprises the piece. An additional advantage of this boosters piece embodiment is its symmetry, which allows to mount the piece at any position on a clearance of the ground plane layer of the radiating structure. This boosters piece can also be configured in some radiating structure embodiments such that one via is connected to ground and the other to a feeding.

As introduced before, the FIG. 14 provides the radiofrequency system used for matching a radiating system that comprises a radiating structure containing a boosters piece 150 like the one shown in FIG. 13. A filter 1610 rejecting Bluetooth frequencies is mounted before the matching network used for matching the port P116 at GNSS frequencies, the filter being a parallel circuit composed, in this particular example, of an inductor 1611 connected in parallel to a capacitor 1612, and the matching network composed of a series capacitor 1613 followed by a shunt capacitor 1614. Port P216 is matched at Bluetooth frequencies by means of a matching network containing a series inductor 1621 and a series capacitor 1622. Other matching network topologies can be used in other radiating system embodiments comprising the boosters piece 150 presented in FIG. 13, for achieving the sought input matching performance at the ports P116 and P216, usually matched for operation at GNSS and Bluetooth frequencies. The values of the circuit components included in the radiofrequency system described before and shown in FIG. 14 are also provided in this Figure.

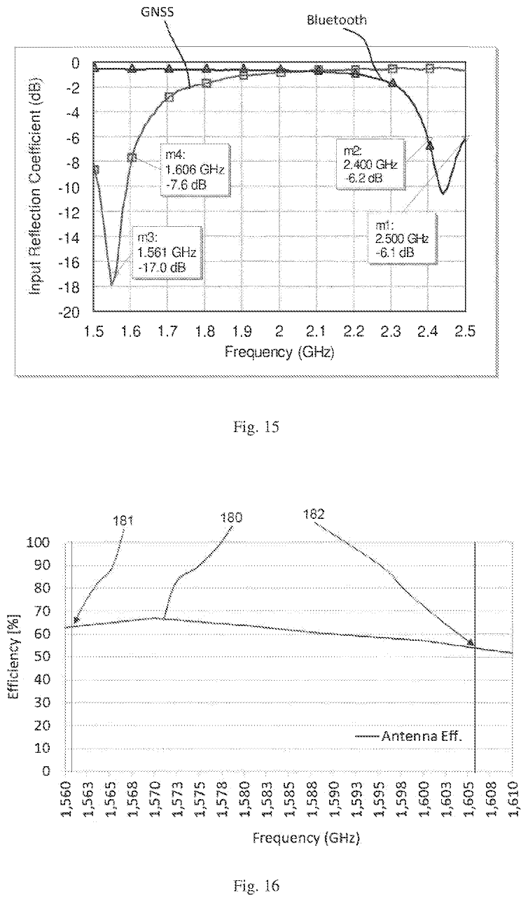

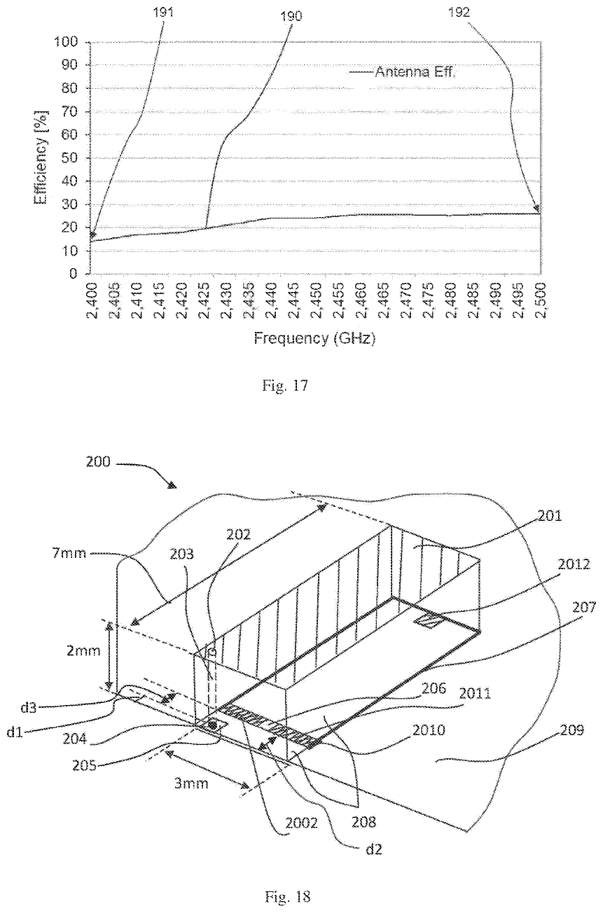

FIG. 15 provides the input reflection coefficient achieved for a radiating system according to this invention comprising a radiating structure that contains a boosters piece 150 and a radiofrequency system like the one provided in FIG. 14. The curves GNSS and Bluetooth from FIG. 15 show the matching performance achieved at GNSS and Bluetooth services, for which the corresponding frequency bands of operation go between 1.561 GHz to 1.606 GHz for GNSS service and between 2.4 GHz to 2.5 GHz for Bluetooth service. Good matching values, below −6 dB, are obtained for a radiating system embodiment of two ports operating at GNSS and Bluetooth services, the radiating system comprising a radiating structure that contains a boosters piece like the one from FIG. 13 and that comprises a radiofrequency system like the one from FIG. 14. FIG. 16 and FIG. 17 show measured antenna efficiencies related to this last radiating system embodiment. FIG. 16 provides the antenna efficiency related to the GNSS port, plotted as curve 180, and FIG. 17 the antenna efficiency related to the Bluetooth port and represented by the curve 190. Antenna efficiency averages above 65% and above 20% are achieved and measured at the GNSS frequency band and at the Bluetooth frequency band, respectively. The antenna efficiencies achieved at the limit frequencies of each band are represented by markers 181, 182, 191 and 192, markers 181 and 191 pointing the antenna efficiencies at the minimum frequencies and markers 182 and 192 pointing the antenna efficiencies at the maximum frequencies.

Another embodiment of a boosters piece 200 according to the present invention is provided in FIG. 18. This piece features 7 mm×3 mm×2 mm (L×W×H) dimensions, so its length to width ratio is larger than 1. This piece comprises a first booster comprising a conductive surface 201 on the top face of the piece, the conductive surface containing in this case just one connection point 202, the connection point connecting the conductive surface to a vertical via 203 that is connected at its other end to a feeding point 204, the feeding point in a conductive pad 205, as shown in FIG. 18, for allowing electrical connectivity with the radiofrequency system of the radiating structure on which the piece is mounted. The second booster of the boosters piece 200 comprises a slot defined by curve 207 contained in a clearance 208 of the ground plane layer 209 on which the boosters piece is mounted. In the radiating structure embodiment provided in FIG. 18, the slot is included in the middle of one of the longest edges of the ground plane layer 209. The slot is fed by the strip line included in the boosters piece, the strip line 206 featuring 0.5 mm width, connected to a feeding point 2010 at an end and to the ground plane layer of the radiating structure at its other end. The vertical via 203 is positioned at a distance d1 defined from the short edge of the boosters piece from which the feeding conductive strip of the second booster is located, the distance d1 defined for the case of a via element to the center of the via. As already mentioned, this piece also contains a second booster comprising a conductive strip 206 at a distance d2, 1.5 mm for this particular embodiment, from the short edge of the piece closest to the feeding via 203 of the first booster, so the conductive strip also located at a distance d3 from the via, 1 mm for this particular example from the center of the via. This boosters piece is characterized by having a strip line 206 positioned at a distance d2 greater than the distance d1 at which the via 203 is located, so that the first booster's feeding point 204 is outside the slot that the strip line excites once the piece mounted on the PCB that contains the whole radiating system. It has been found that by allocating the first booster's feeding point in a position outside the slot excited by the conductive strip included in the second booster, as it is the case of this boosters piece embodiment, further improves isolation between boosters and between the radiating system ports related to those boosters. A better isolation of the radiating system ports provides more performant and robust embodiments in terms of operation, more specifically regarding the efficiency achieved. Another feature of a radiating structure and a radiating system that comprises a boosters piece 200 like the one presented in FIG. 18 is that the slot excited by the conductive strip 206 is not as big as the ground plane clearance where the boosters piece 200 is integrated. In this embodiment some conductive pads 2011 are included and printed along the strip line for enabling electrical connection between the boosters piece and the PCB containing the radiating structure and system. The pads printed along the strip line enhance the interaction between the strip line and the slot in the ground plane of the radiating structure. One floating or non-electrical conductive pad 2012 is added in the piece provided in FIG. 18 for mechanical reasons, i.e., for having more soldering points of the piece to the PCB that allocates the radiating system.

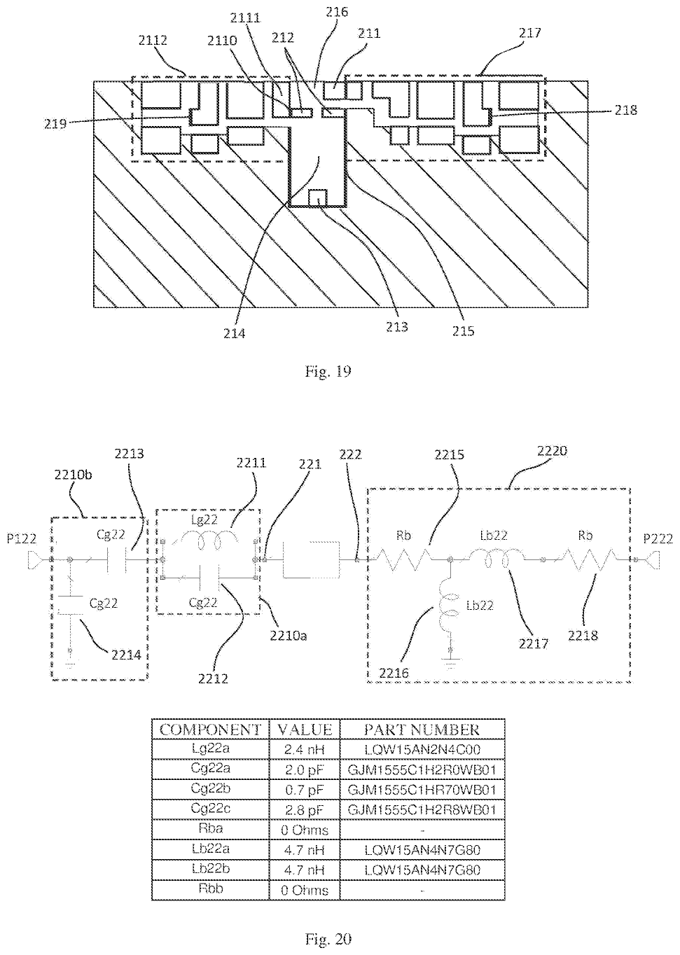

FIG. 19 shows a footprint of a booster's piece like the one provided in FIG. 18, together with the pads used in this radiating structure example for allocating a radiofrequency system that typically enables operation at two ports, covering in some embodiments operation at GNSS and Bluetooth frequency bands. In some other embodiments this radiating structure is configured to provide operation at just one port. The dimensions of the ground plane layer of the radiating structure embodiment provided in FIG. 19 are 80 mm in length×40 mm width, and the boosters piece from FIG. 18 is placed at a middle point of a long edge of the ground plane layer. When integrating the booster's piece from FIG. 18 in the whole radiating structure, the feeding point conductive pad 205 is soldered to the feeding conductive pad 211 of the piece footprint, the strip line pads 2011 are soldered to the strip line pads 212 included on the PCB footprint and the mechanical pad 2012 included in the booster's piece is soldered to the conductive pad 213 included in the footprint just for mechanical reasons. In the footprint shown in FIG. 19, it is clearly evidenced that the slot 214 defined by curve 215 in the clearance 216 of the ground plane does not contain the footprint pad 211 in it, pad that is connected to the first booster's feeding point pad 205 when the piece is mounted on the PCB. Consequently, the pads area 217 implemented for allocating a matching network, and a filter if needed, for matching the port 218, which is related to the first booster included in the piece, at the sought frequencies is not interfering the slot operation. So, a radiating structure embodiment like the one provided in FIG. 19, allocating a booster's piece like the one provided in FIG. 18, advantageously features good isolation between ports 218 and 219, and provides a performant and robust embodiment, particularly in terms of efficiency.

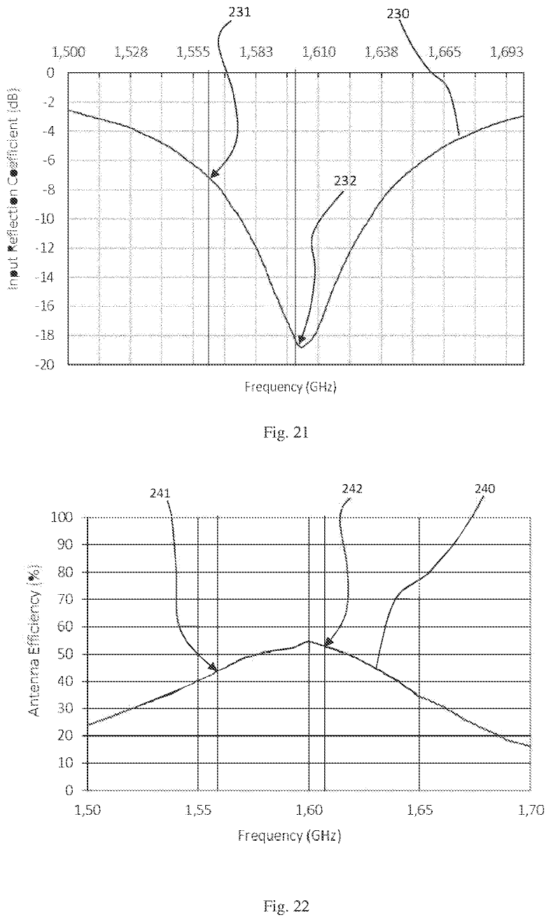

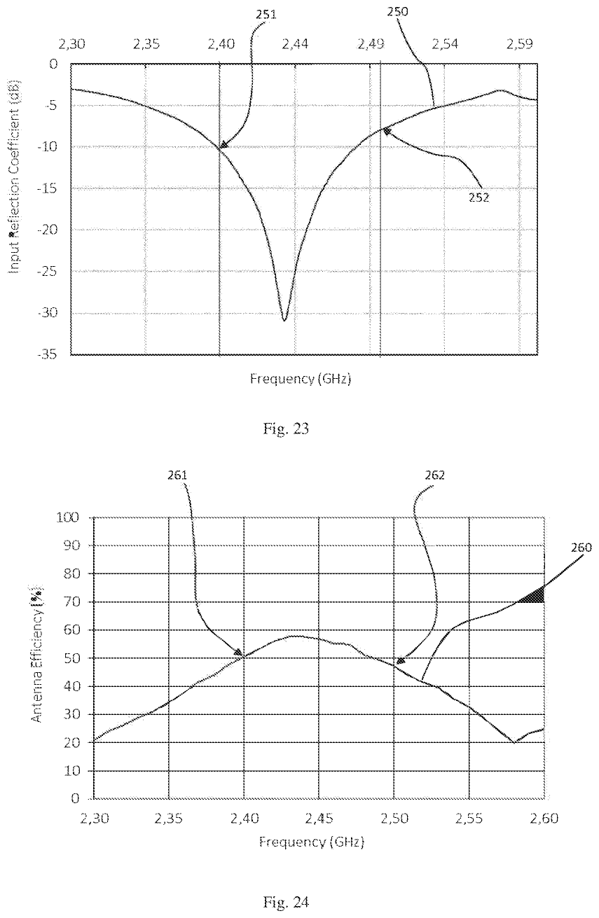

A particular embodiment of a radiating system comprising a radiating structure described before and featuring a boosters piece footprint provided in FIG. 19, is a dual-port radiating system configured to operate at Bluetooth and GNSS frequency bands by including the radiofrequency system provided in FIG. 20. The radiofrequency system comprises a Bluetooth filter 2210a and a matching network 2210b connected to the feeding point 2110 through a first pad 2111 of the pads area 2112 for matching the port 219 at GNSS frequencies and it comprises a matching network 2220 without any filter connected at the feeding conductive pad 211 for matching port 218 at Bluetooth frequencies. The values and the part numbers of the real circuit components of the radiofrequency system shown in FIG. 20 are also provided in this Figure. Good matching values are achieved at both ports 218 and 219 after including the radiofrequency system described just before in a radiating structure like the one shown in FIG. 19, the radiating structure comprising a boosters piece 200 like the one illustrated in FIG. 18. FIG. 21 and FIG. 22 show the input reflection coefficient and the antenna efficiency, respectively, provided at port 219, at GNSS frequencies. Input reflection coefficients below −6 dB and antenna efficiencies above 40% are obtained for the whole band, which extends from 1.561 GHz to 1.606 GHz. The markers 231, 241 and 232, 242 included in FIG. 21 and in FIG. 22 point to the minimum and maximum frequencies, respectively, of the GNSS band. An antenna efficiency average above 50% is achieved for this frequency band of operation at port 219. Regarding port 218, which is matched for operating at Bluetooth frequencies, FIG. 23 and FIG. 24 show the input reflection coefficient and the antenna efficiency, respectively, provided at the port at those frequencies. Input reflection coefficients below −7 dB and antenna efficiencies above 45% are obtained for the whole band, which extends from 2.4 GHz to 2.5 GHz. The markers 251, 261 and 252, 262 included in FIG. 23 and in FIG. 24 point to the minimum and maximum frequencies, respectively, of the Bluetooth band. An antenna efficiency average above 40% is achieved, then, at the port 218 of an embodiment of the radiating system provided in FIG. 19 that comprises the radiofrequency system provided in FIG. 20 and the boosters piece from FIG. 18. The efficiencies obtained for this embodiment evidences improved isolation between ports with respect to a radiating system comprising two ports and a radiating structure comprising a boosters piece like for example the one from FIG. 13, which contains the feeding via of the first booster within the slot of the second booster.

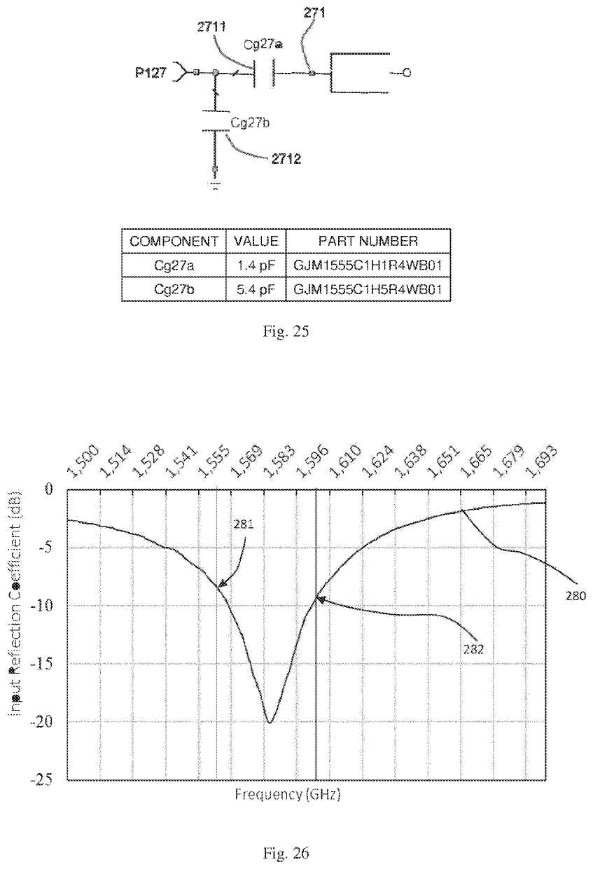

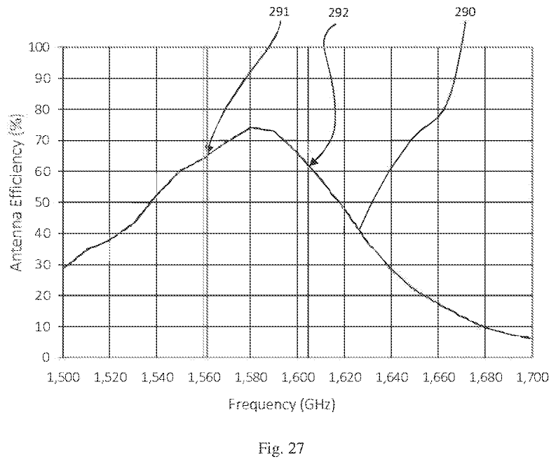

Another embodiment of a radiating system comprising a radiating structure featuring the boosters piece footprint shown in FIG. 19 and comprising the boosters piece from FIG. 18, is a single-port radiating system, configured to operate for this particular case at the GNSS frequency band by including and mounting the radiofrequency system provided in FIG. 25 in the pads topology also provided in FIG. 19. A single-port radiating system embodiment does not normally comprise any filter, as it is the case of the radiofrequency system from FIG. 25, which comprises a matching network but not a filter, the matching network connected to the feeding pad 2111 of the pads area 2112 from FIG. 19, for matching the port 219 at GNSS frequencies. The values and the part numbers of the real circuit components of the radiofrequency system provided in FIG. 25 are also included in this figure. The port 218 is not matched for this particular case, so no matching network is included in the pads area 217. The input reflection coefficient related to the port 219 of the single-port embodiment described above is provided in FIG. 26. Good matching values below −8 dB are achieved in the entire GNSS band, which extends from 1.561 GHz to 1.606 GHz, and antenna efficiencies above 60% are obtained, as observed in FIG. 27. The markers 281, 291 and 282, 292 included in FIG. 26 and in FIG. 27, point to the minimum and maximum frequencies, respectively, of the GNSS band. An antenna efficiency average above 65% is achieved for this particular embodiment at port 219 at the GNSS band of operation.

What is claimed is:

1. A wireless device comprising a radiating system comprising:
at least one port; and
a radiating structure comprising:
a ground plane layer comprising a clearance containing a slot defined by a curve, the curve containing first and second connecting points;
at least one booster arrangement comprising first and second boosters arranged in a non-concatenated disposition and at least partially included in a boosters piece mounted on the clearance of the ground plane layer, the boosters piece having a largest dimension smaller than λ/20, where λ is the free-space wavelength corresponding to a lowest frequency of operation of the radiating system, the first booster comprising a conductive element including at least one connection point connected to an additional conductive element contained in the boosters piece, the additional conductive element comprising a feeding point, the second booster comprising a feeding element comprising a feeding point, the feeding element being connected to the first and second connecting points of the curve defining the slot of the ground plane layer and being positioned at a distance d2 from a closest edge of the boosters piece, wherein the additional conductive element of the first booster is positioned at a distance d1 from said closest edge of the boosters piece to the feeding element; and
at least one radiofrequency system connected to the feeding points of the first and second boosters.

2. The wireless device of claim 1, wherein the radiating system comprises first and second ports and the radiating structure is configured to provide operation at the first and second ports.

3. The wireless device of claim 1, wherein the radiating system comprises one port and the radiating structure is configured to provide operation only at the one port.

4. The wireless device of claim 1, wherein the boosters piece has a length to width ratio greater than 1, wherein the width is a dimension along which the slot feeding element is contained and the length is perpendicular to and in a same plane as the width.

5. The wireless device of claim 1, wherein the boosters piece has a length to width ratio less than 1, wherein the width is a dimension along which the slot feeding element is contained and the length is perpendicular to and in a same plane as the width.

6. The wireless device of claim 1, wherein the radiofrequency system comprises a same number of filters as a number of ports in the radiating system.

7. The wireless device of claim 1, wherein the radiofrequency system comprises fewer filters than a number of ports in the radiating system.

8. The wireless device of claim 1, wherein the ground plane clearance is as big as a footprint of the boosters piece.

9. The wireless device of claim 1, wherein the ground plane clearance is larger than a footprint of the boosters piece.

10. The wireless device of claim 1, wherein the slot of the ground plane clearance is as large as the ground plane clearance.

11. The wireless device of claim 1, wherein the slot of the ground plane clearance is smaller than the ground plane clearance.

12. The wireless device of claim 1, wherein the feeding element is located at zero distance from the closest edge of the boosters piece.

13. A wireless device comprising a radiating system that comprises:
first and second ports; and
a board including a radiating structure, the radiating structure comprising:
a ground plane layer comprising a clearance containing a slot defined by a curve, the curve containing first and second connecting points;
a boosters piece mounted on the ground plane clearance and comprising at least portions of first and second boosters arranged in a non-concatenated disposition and at least one non-electrical connection element affixing the boosters piece to the board that contains the radiating structure, the first booster comprising a conductive surface contained in a top surface of the boosters piece and including at least one connection point connected to a via of the boosters piece, the via comprising a feeding point, the second booster comprising a feeding conductive strip contained in the boosters piece, the feeding conductive strip being positioned at a distance d2 from a closest edge of the boosters piece and being connected to the first and second connecting points of the curve defining the slot of the ground plane layer and containing a feeding point, wherein the via is positioned at a distance d1 from said closest edge of the boosters piece to the feeding conductive strip, and wherein the boosters piece features a largest dimension smaller than λ/20, where λ is the free-space wavelength corresponding to a lowest frequency of operation of the radiating system; and
a radiofrequency system connected by conductive pads to at least one of the feeding point of the first booster or the feeding point of the second booster.

14. The wireless device of claim 13, wherein the first booster contains only one via.

15. The wireless device of claim 13, wherein the boosters piece is a symmetric piece and contains the first booster, wherein the first booster comprises first and second vias.

16. The wireless device of claim 13, wherein the at least one non-electrical connection element comprises one or more connecting pads.

17. The wireless device of claim 13, wherein the at least one non-electrical connection element comprises a strip line.

18. The wireless device of claim 13, wherein the at least one non-electrical connection element comprises a U-shaped strip line.

19. The wireless device of claim 13, wherein the distance d2 is greater than the distance d1.

20. The wireless device of claim 13, wherein the distance d2 less than the distance d1.
